(19) United States
(12) Patent Application Publication
(10) Pub. No.: US 2011/0147485 A1
(43) Pub. Date: Jun. 23, 2011

(54) HEATING SCREEN AND INJECTION DEVICE INCLUDING SUCH SCREEN

(76) Inventors: Pascal Perruchot, Chalons En Champagne (FR); Jean-Sébastien Fromont, Sarry (FR)

(21) Appl. No.: 12/973,776

(22) Filed: Dec. 20, 2010

(30) Foreign Application Priority Data
Dec. 22, 2009 (FR) 0959405

(51) Int. Cl. B05B 1/24

(52) U.S. Cl. 239/133

(57) ABSTRACT

This invention relates to a heating screen device characterized in that it comprises a central intake part (210) comprising means for intake (274) associated to a filtering element (220) in direct contact with the fluid to be sucked, and a heating part (250) separate from the central intake part (210), placed at the periphery of the latter and comprising heating elements 92, 294, 296).

This invention relates to the domain of the drawing out of fluids in a tank installed in a motor vehicle.

Many devices for this purpose have already been proposed.

One of the difficulties posed by the drawing out of fluids in motor vehicles is due to the substantial difference in temperature that these fluids and devices for drawing out must withstand.

Typically, the devices for drawing out installed on motor vehicles must remain operational over a temperature range from −30° C. to +60° C.

The difficulties appear most particularly at very low temperatures.

More precisely, this invention applies most particularly to injection systems of a solution of urea or similar aqueous additives, in a motor vehicle exhaust line.

In this field, those skilled in the art know various nitrogen oxide treatment devices by catalytic reduction using aqueous additives, for example a solution of urea, injected into or upstream of a catalyzer.

At a high temperature, in the exhaust line, urea breaks down into ammonia and carbon dioxide.

The ammonia in turn reacts with the nitrogen oxides to form nitrogen and water.

However, the aqueous additives proposed until now, in particular the solution of urea, freeze at low temperature. In particular, the 32.5% solution of urea in demineralized water freezes starting at −11° C.

In winter, when motor vehicles are started, the content of the tank of additives, in particular of the solution of urea, can thus be entirely frozen, although the urea injection system installed on the vehicle must according to standards be operational no later than 20 minutes after the engine is started.

The first heaters proposed for this purpose, are comprised of a coil comprising a heating resistance. Although promising initially, these known devices do not provide entire satisfaction. It is shown that, with use, they have the disadvantage of generating hot spots of which the temperature can exceed more than 100° C. in a portion outside of the fluid. Yet, at this temperature certain components made of plastic material forming the device for drawing out, can be degraded. Finally, the coil itself can reach it melting temperature.

In this context, this invention has for objective to propose a rapid and energy-saving heating device that can apply in particular to a tank of urea making it possible to rapidly molt the volume of additives required for the proper operation of a nitrogen oxide catalytic reduction system.

This invention proposes a heat screen device characterized in that it comprises:

a central intake part comprising means of intake associated to a filtration element in direct contact with the fluid to be sucked, and

a heating portion placed in a case, separate from the central intake part, placed at the periphery of the latter and comprising electrical heating elements.

The aforementioned combination of characteristics in accordance with this invention, make it possible to disassociate the intake portion and the heating portion which still allowing for the following technical effect. The heating portion makes it possible to effectively heat the fluid to be sucked with the purpose of fluidifying the latter. The filtration element has a direct access to the fluids to be sucked without this fluid however having to pass through a heating layer.

In addition, the aforementioned arrangement allows for a simple and inexpensive structure to be carried out. Indeed, the heating portion has a structure that is independent to that of the central intake part, which makes it possible to arrange the heating portion in a hermetic and sealed jacket.

As such, the elements that comprise the heating portion do not directly undergo the corrosive attack of the fluid to be sucked. This makes it possible to obtain a device with a long life span. In addition, the electrical connections between. the heating elements and the power wires can he protected. simply from the fluid to be sucked thus avoiding any electrical risks.

According to other advantageous characteristics the invention:

the heating portion has an annular form around the intake portion,

the heating portion comprises a support element of heating elements, which makes it possible to guarantee a predetermined distance between said elements and the jacket of the heating portion in order to avoid any problem of deterioration,

a lower part made of plastic material and an electrically conductive upper lid are provided defining he an annular housing which receives at least one positive coefficient thermistor,

the housing contains an electrically conductive annular part used as a contact with the positive coefficient thermistors,

the contact part has elastic blades for solicitation,

the annular contact part comprises positioning rivets for the thermistors,

the annular contact part comprises at least one angular indexing means,

the annular contact part comprises an electrical contact blade formed by cutting and folding,

the upper lid provides the electric contact between the mass of the vehicle and the heating portion. This system has only one electrode in contact with the aqueous solution; the phenomena of galvanic dissolution of metals are as such avoided.

the upper lid covers an intake chamber surrounded by the heating portion and which houses a filtering element,

the lower part of the screen made of plastic material is countersunk and glued on the lid made of electrically conductive material,

a rod is provided made of heat conductive material, inked to the upper wall of the heating portion and in contact with the output of a pressure regulator,

said rod is mounted with telescopic displacement an the output of the pressure regulator,

the support element comprises resilient protuberances,

the support element comprises fastening protuberances allowing for the fastening of the heating elements,

the support element further comprises receiving holes intended to receive protuberant parts so that the cooperation between the two allows for a better positioning of the support element,

the heating portion has a cylindrical form with a section with the same geometry as the bowl thus allowing for a centering of the screen in a bowl,

the heating portion ha a cylindrical form of circular section,

the heating portion is coaxial to the central intake part,

the central intake part comprises one or more ribs allowing for the support and the consolidation of the filtration element,

a guide tube is provided making it possible to simplify and to secure the insertion of the device in a bowl,

a sheath is provided for the protection of the electrical power wires.

Other characteristics, purposes and advantages of this invention shall appear when reading the detailed description which shall follow and with regards to the annexed drawings, provided by way of a non restricted example and wherein:

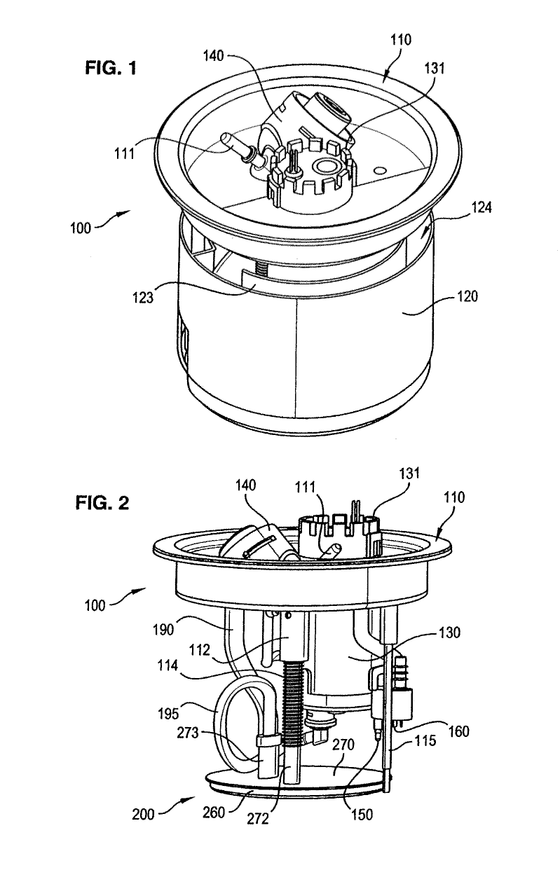

FIG. 1 shows a diagrammatical view in perspective of a device for full drawing out in accordance with this invention,

FIG. 2 shows a partial view of the same device, with the reserve bowl removed,

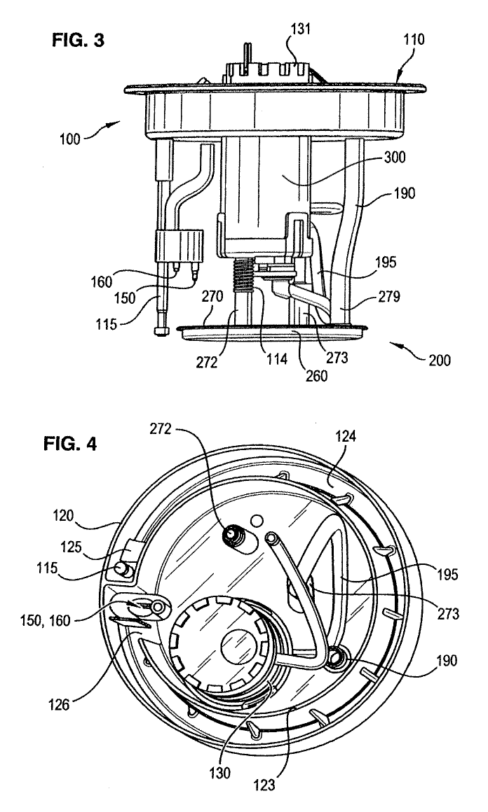

FIG. 3 shows a lateral view of the device shown in FIG. 2,

FIG. 4 shows a top view of the same device, after removal of an upper base,

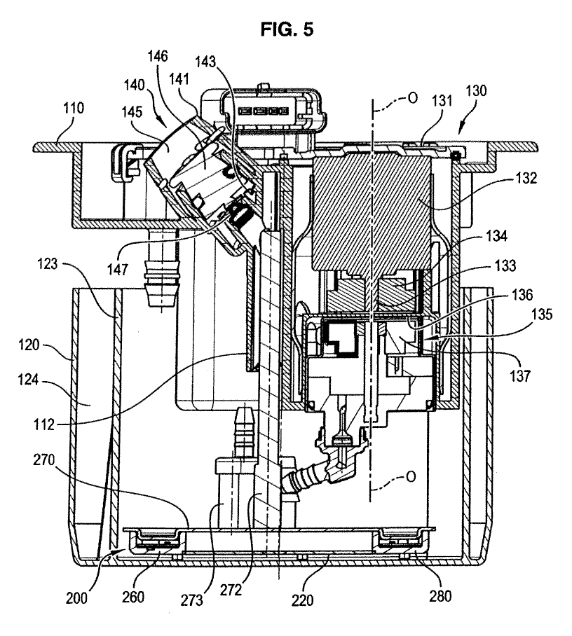

FIG. 5 shows a vertical section view of the device for drawing out in accordance with this invention,

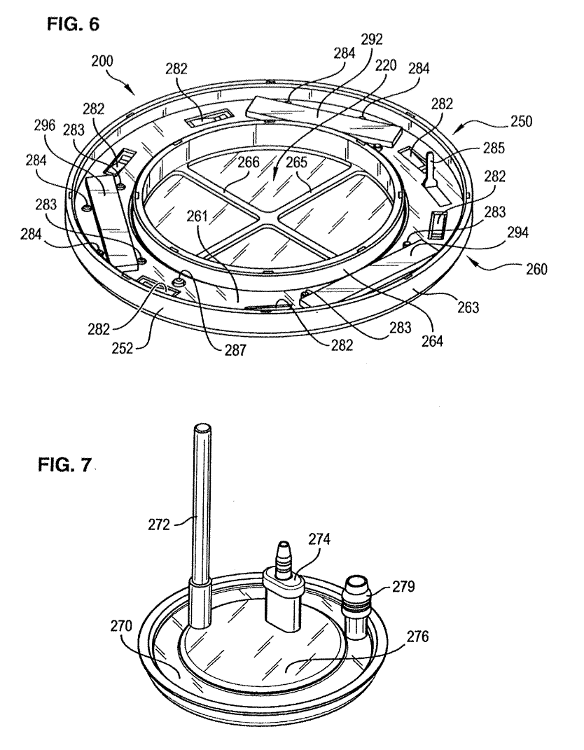

FIG. 6 shows a partial perspective view of a heating screen in accordance with this invention, after removal of an upper metal plate from the latter,

FIG. 7 shows a perspective view of said metal plate not shown in FIG. 7 and covering the screen,

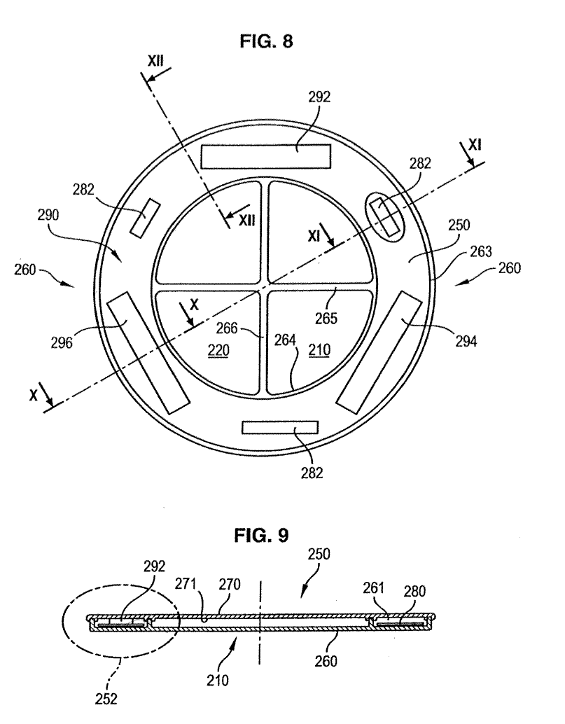

FIG. 8 shows an outline sketch of the base of the screen shown in FIG. 6, provided with heating resistances formed of thermistors,

FIG. 9 shows a vertical section view of the heat leg screen in accordance with this invention, and

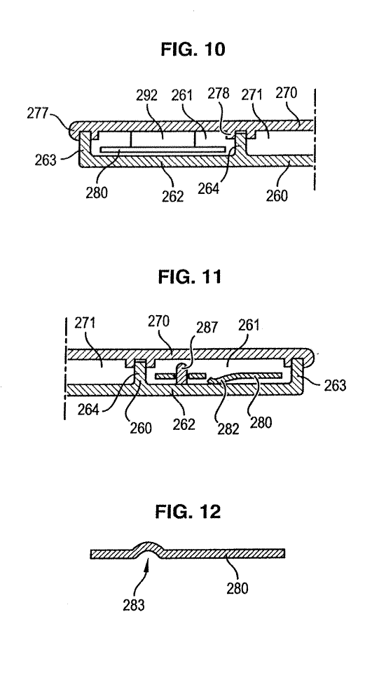

FIGS. 10, 11 and 12 show three partial vertical section views of the some heating screen according to three section planes referenced respectively as X-X, XI-XI and XII- XII in FIG. 8.

The complete system intended to equip a motor vehicle within the framework of this invention, comprises a drawing out module 100 and an electronic control. The electronic control is intended to control an electric pump, a heater and an injector and to provide all of the processing of the measuring of the temperature and of the fluid level.

The electronic control unit being however generally known to those skilled in the art, it will not be described in detail in what follows. The rest of this description will therefore focus on describing exclusively the drawing out module 100 in accordance with this invention.

This drawing out module 100 substantially comprises:

a base 110 intended to be fastened in an opening formed on the upper wall of a tank of additives, for example of urea,

a bowl 120 located at the base of the module and intended to contain a reserve of additives wherein the fluid is sampled,

an electric pump 130 which pumps the additive in the bowl 120,

a pressure regulator 140,

a temperature sensor 150 intended to measure the temperature of the additive in order to control in consequence the operation of the heater,

a low-level alert sensor 160 intended to alert the driver of the motor vehicle that the level of additive in the tank has reached a low level, and an intake screen 200 incorporating a heating device 250.

As shall be specified in what follows, the electric pump 130 is more preferably a pump comprising an internal magnetic coupling between an electric drive part and a mechanical pumping part, in such a way that the electric drive motor part is entirely separated from the mechanical pumping part and with this entirely separated from the fluid to be sucked.

The intake screen 200 is placed in the bowl 120, at the base of the latter. It is supported starting from the base 110 by a telescopic assembly allowing for a relative displacement between the base 110 and the screen 200 in order to index the screen 200 at the bottom of the reserve bowl 120.

As indicated hereinabove, the intake screen 200 comprises a central intake part 210 comprising means of intake associated to a filtration element 220 in direct contact with the fluid to be sucked, and a heating portion 250 separate from the central intake part 210, placed at the periphery of the latter and comprising heating elements 290.

The heating portion 250 of the screen 200 is more preferably placed in a case 252 formed by a lower part 260 made of plastic material and by an upper part 270 made of metal, for example of stainless steel.

The aforementioned telescopic assembly of the screen 200 in relation to the upper base 110 is more preferably formed from a solid vertical tube 272 integral with the upper surface of the part 270, mounted slidingly in a tubular tip 112 protruding on the lower surface of the base 110 and communicating with the output of the regulator 140.

The tube 272, in contact with the part 270, is made from a good heat conducting material in order to transfer the temperature of the part 270 from the heater 250 to the output of the pressure regulator 140.

A spring 114 inserted between the tip 112, linked to the base 110, and a protuberance of the tube 272, provide a solicitation of the screen 200 towards the base of the bowl 120. Said metal part 270 forming the upper portion of the screen 200 comprises moreover a hollow tip 274, located substantially at its center. The tip 274 exits onto the lower surface of the part 270, across from the central intake part 210. It is extended upwards, at the exterior of the screen 200, by a flexible duct 295 ending at the input of the electric pump 130 in order to be used as a fluid intake inlet.

In FIG. 1, 111 is referenced as a tip or pipette coming from the regulator 140 and intended to be connected to an injection line.

The output lid of the motor of the electric pump 130 is referenced 131 in FIGS. 1 and 2.

The base 110 also supports, on its lower surface, more preferably on its external periphery, a vertical column or tube guide 115 extending substantially over the entire height of the module and of which the lower end exits laterally next to the case of the screen 200. This rod guide 115, more preferably telescopic, is used for centering in the bowl 120.

Under reference 190 in the figures is shown a sealed tube which connects an electrical connector formed on the base 110 and the upper surface of the metal part 270 of the screen 200. This tube 190 receives the electrical power cables of the heating element 290 placed in the case 252 of the screen 200. Such a duct 190 makes it possible to protect the electrical power cables by avoiding their contact with the fluid to be sucked. The duct 190 is flexible in order to accompany any relative displacement between the base 110 and the screen 200.

The reserve bowl 120 can he subject, in itself, to many embodiments known to those skilled in the art and include all of the dispositions making it possible to maintain the fluid to be sucked inside the bowl 120. To this effect, the bowl 120 can include for example a vertical internal wall 123 delimiting a spiral 124 which can be seen in part in FIG. 1. The spiral 124 covers a substantial portion of the periphery of the bowl 120. It is connected at one end, by an opening 125, to the internal volume of the tank of additives, and it exits at its other end 126 into the internal volume of the bowl 120 (see FIG. 4).

In order to provide a centering and a maintaining of the bowl 120, in relation to the screen 200, more preferably the straight horizontal section of the case 252 is equal to the straight horizontal section of the internal chamber of the bowl 120 delimited by the wall 123 forming the spiral 124, while the rod guide 115 is placed in the spiral 124.

The rotating electric pump 130 is a pump comprised of two separate parts: an electric control part 132 and a mechanical pumping part 135.

The electric control part 132 comprises more preferably a wound external stator adapted to generate during adequate electrical power a rotating electrical field making it possible to rotate a rotor linked to a shaft 133.

The electric control part 132 and the mechanical pumping part 135 are separated, more preferably, by a sealed partition 136.

The use of an electric pump comprising two compartments, one for the electric control 132, the other for pumping mechanics 135, separated by a sealed partition 136, makes it possible to avoid any leaking of additives towards the electrical winding 132.

The transmission of the rotating movement between the rotor of the electric control part 132 and an element across from the mechanical pumping part 135, is operated thanks to permanent magnets or any equivalent means, one 134 integral with the shaft 133, on the side of the wall 136 located in the chamber housing the electric control part 132, and the other 137 located across from the other side of the sealed wall 136 in the chamber housing the mechanical pumping part 135.

The mechanical pumping part 135 can be subject to many embodiments. This is more preferably a gear system. of which the input shaft is mounted in rotation around an axis O-O aligned. en the axis of the rotor 132.

The electric pump 130 is more preferably a brushless pump.

The regulator 140 more preferably comprises as diagrammed in FIG. 5, a case 141 divided into two chambers 143, 145, by a membrane or an equivalent means 146.

A first chamber 143 communicates with the output of the mechanical pumping part 135, via any appropriate means.

The second chamber 145 of the pressure regulator 140 houses a weighted spring or an equivalent means which solicits the membrane 146 against a valve 147 located in the first chamber 143. The output of the valve 147 communicates with the aforementioned tip 112 forming a return of additives which exits above the screen 200.

As long as the pressure supplied by the output of the pump 130 is less than the effort applied on the membrane 146, the latter is applied against the valve 147 and no additive is delivered by the output duct 112.

On the contrary, when the output pressure of the mechanical pumping part 135 exceeds the setpoint effort, the membrane 146 is separated from the valve 147. Consequently, the excess in the pressure of additives fed by the pump 130 is returned on the screen 200 by the intermediary of the tip 112.

We shall now describe the structure properly speaking of the screen 200 provided with a heater in accordance with this invention with regards to FIG. 6 and the following as annexed.

As mentioned hereinabove, the screen 200 comprises a base 260 made of electrically insulating plastic material covered with a metal part 270. These two parts 260, 270 define in combination a sealed annular chamber 261 intended to receive the means of heating 290. These means of heating 290 include at least one positive coefficient thermistor and more preferably, as shown in FIG. 6, three positive coefficient thermistors 292, 294 and 296.

To this effect, the base 260 is formed more preferably of a flat ring 262 provided with respectively two walls 263, 264 protruding on its upper surface: a cylindrical wall 263 on its radially external periphery and a similar cylindrical wall 264 on its radially internal periphery. The two aforementioned cylindrical walls 263, 264, protruding on the upper surface of the ring 262 define the annular housing 261.

The part 260 also more preferably comprises at its center two orthogonal ribs 265, 266 between them and secant to the center of the part 260. The two ribs 265 and 266 form a cross making it possible to support, according to any appropriate means, a filtering membrane 220.

The membrane 220 can be fixed on the ribs 265, 266 by any appropriate means, for example by gluing or heat weld.

The part 260 is fastened on the lower surface of the upper part 270 forming a lid by any appropriate means, for example by countersinking.

To this effect, more preferably, the upper part comprises a plate 276 in the form of a disc provided more preferably, on its lower surface, with two annular grooves 277, 278 intended to receive respectively the upper edge of the cylindrical walls 263 and 264.

More preferably, the plastic part 260 is fastened by gluing on the upper metal part 270 on the tops of the walls 263, 264 countersunk in the annular grooves 277, 278.

The electrically conductive upper metal part 270 is connected to one of the power terminals of the battery of the motor vehicle, more preferably the mass of the latter, by a wire placed in the protective tube 190.

The screen moreover comprises an additional metal part 280 forming a contact counter-electrode, in the form of a ring, placed in the bottom of the annular housing 261 in contact with the base 260. The thermistors 292, 294 and 296 are as such placed between the metal lid 270 and the metal reverse part 280. The latter is connected to the second terminal of the battery of the motor vehicle in order to make it possible to supply the thermistors 292, 294, 296.

The electrical connection between the annular part 280 and the battery of the vehicle can be carried out by any appropriate means. It must of course be insulated electrically from the lid 270. More preferably the power line connected to the annular part 280 is placed in the enter of a hollow tip 279 protruding on the upper surface of the metal part 270 and extended by the protective duct 190.

As can be seen in FIG. 11, more preferably, the annular connection part 280 has a plurality of elastic blades 282 formant a spring, equally-distributed angularly over its periphery and coming to rest against the upper surface of the base 260. The blades 282 solicit the annular connection part 280 upwards. The thermistors 292, 294, 296 are pinched between the upper surface of said annular part 280 and the lower surface of the lid 270, in order to guarantee a reliable contact on the two terminals of the thermistors 292, 294, 296, despite the vibrations inherent to the vehicle. Said blades 282 are formed by one-off cut-outs arranged in the mass of the annular part 280 and equally distributed along the latter. It is as such provided according to the particular and non-restricted embodiment shown in the annexed figures, six blades 282 equally distributed over the contour of the part 280.

FIG. 6 also shows a contact blade 285 formed by cutting out from the mass of the part 280 and folded upwards 90° in order to protrude from the aforementioned tip 279 and provide the electrical power connection of the thermistors 292, 294 and 296.

FIG. 12 also shows the carrying out of rivets 283, 284 protruding on the upper surface of the part 280, formed by stamping and arranged in order to define locations for receiving thermistors 292, 294, 296.

More precisely, as can be deduced when examining FIG. 6, each thermistor 292, 294, 296 has a rectangular contour and more preferably for each thermistor four rivets are provided protruding on the upper surface of the part 280 i.e. two rivets 283 located on the same internal radius and two rivets 284 located on the same upper external radius.

The four rivets 283 and 284 respectively associated to each thermistor, define between them an additional space of the contour of a thermistor. Each thermistor is as such radially immobilized. It is moreover angularly immobilized as its great length is at least substantially equal to the chord defined by the rivets 284, inside the chamber 261.

Moreover, more preferably, an angular full-proof device is provided defining an angular indexing of the part 280 in relation to housing 261 in the form of a pin 287 protruding on the upper surface of the part 260 and penetrating into a corresponding bore of the annular contacting part 280 in order to guarantee a correct positioning of the contacting blade 285 during the assembly.

The contacting part 280 is made more preferably of stainless steel, as the lid part 270.

When the temperature sensor 150 detects a low temperature, the electronic control module provides the power for the thermistors 292, 294, 296. The electrical power of these components results in a rise in temperature of the latter which makes it possible to heat the metal disc 276 comprising the lid 270 of the screen. The calories distributed as such are sent to the output 112 of the regulator 140 by the tube 272.

More preferably, the output 112 of the regulator is itself comprised of a good heat conductor metal tube which makes possible the transfer of the heat of the heater 200 coming from the tube 272, towards the regulator 140.

The disc 276 forming the lid part 270 covers in its center a cylindrical chamber 271 surrounded by the case 252 forming the annular housing 261. The chamber 271 contains the filtration element 220 carried by the ribs 265, 266.

The internal volume of this chamber 271 is connected to the input of the pump 130 by the tip 274 protruding on the upper surface of the part 270 and extended by a sealed duct 195 which ends at the intake inlet of the pump.

The operation of the device which has just been described is substantially as follows.

In normal operation, the electric pump 130 sucks the additive through the filter 220, in the bowl 120, more precisely in the chamber 271, via the tip 274, via the duct 195, and directs the additive pumped as such, at its exit, towards the regulator 140. The excess additive is returned to the base of the bowl 120 by the output tip 112. The additive with regulated pressure is directed towards the injection line by the tip 111.

When the temperature detected by the sensor 150 is less than a threshold, the electronic control module powers the thermistors 210, 212 and 214. The upper wall 276 of the screen 200 is then heated and calories are sent to the output of the regulator 140 by the intermediary of the duct 272.

The invention as such makes it possible to obtain a device for drawing out that is operational rapidly, including in extreme cold.

Those skilled in the art will appreciate in particular that the support element of the heating elements 292, 294 and 296, formed by the contact part 280, makes it possible to guarantee a predetermined distance between the thermistors 292, 294, 296 and the jacket 260 made of plastic material of the heating portion 250 in order to avoid any problem of deterioration.

Of course this invention is not limited to the particular embodiment which has just been described but extends to any alternative that is in accordance with its design.

According to a first alternative embodiment, the solid rod or tube 272 can be hollow by having as such a blind chamber with fluidic link with the output tip 112 of the pressure regulator 140. “Blind” refers to the fact that this tube 272 does not pass through the upper plate 270 of the heater. However, where applicable, such a hollow tube 272 can be split in order to allow to escape at the upper portion of the bowl, the fluid that it receives from the output 112 of the pressure regulator 140.

According to another alternative embodiment in accordance with this invention, the tube 272 can be hollow, with fluidic link with the output tip 112 of the pressure regulator 140 and also with fluidic link with the internal volume 271 of the central intake part located above the filtering membrane, with the condition that the telescopic connection defined between the output tip 112 of the pressure regulator and the tube 272 is sealed in order to prevent the pump 130 from sucking unfiltered liquid which can arrive in the chamber 271, via the tube 272.

1. Heating screen device characterized in that it comprises:
a central intake part (210) comprising means of intake (274) associated to a filtration element (220) in direct contact with fluid to be sucked, and
a heating portion (250) placed in a case (252), separate from the central intake part (210), placed at the periphery of the latter and comprising electric heating elements (292, 294, 296).

2. Device according to claim 1, characterized by the fact that the heating portion (250) has an annular form around the intake part (210).

3. Device according to claim 1, characterized by the fact that the heating portion (250) comprises a support element (280) of the heating elements (292, 294, 296) which makes it possible to guarantee a predetermined distance between said elements (292, 294, 296) and a jacket (260) of the heating portion (250) in order to avoid any problem of deterioration.

4. Device according to claim 1, characterized by the fact that said case (252) comprises a lower part made of plastic material (260) and
an electrically conductive upper lid (270) defining an annular housing (261) which receives at least one positive coefficient thermistor (292, 294, 296).

5. Device according to claim 4, characterized by the fact that the upper lid (270) is connected to one of the terminals of the battery of the motor vehicle.

6. Device according to claim 4, characterized by the fact that the housing (261) contains an electrically conductive annular part (280) used as a contact with the positive coefficient thermistors (292, 294, 296).

7. Device according to claim 6, characterized by the fact that the contact part (280) has elastic blades for solicitation (282).

8. Device according to claim 6, characterized by the fact that the annular contact part (280) comprises rivets (283, 284) for positioning thermistors (292, 294, 296).

9. Device according to claim 6, characterized by the fact that the annular contact part (280) comprises at least one angular indexing means (287).

10. Device according to claim 6, characterized by the fact that the annular contact part (280) comprises an electrical contact blade (285) formed by cutting and folding.

11. Device according to claim 6, characterized by the fact that the upper lid (270) covers an intake chamber (271) surrounded by the heating portion (250) and which houses a filtering element (220).

12. Device according claim 1, characterized by the fact that a lower part (260) of the screen (200), made of plastic material, is countersunk and glued on a lid (270) made of electrically conductive material.

13. Device according to claim 1, characterized by the fact that it comprises a rod (272) made of heat conductive material, connected to an upper wall (270) of the heating portion (250) and in contact with an output of a pressure regulator (140).

14. Device according to claim 13, characterized by the fact that said rod (272) is mounted with telescopic displacement on the output (112) of the pressure regulator (140).

15. Device according to claim 1, characterized by the fact that the heating portion (250) has a cylindrical form of a section with the same geometry as a reserve bowl (120) thus making possible a centering of the screen (200) in the bowl.

16. Device according to claim 1, characterized by the fact that the heating portion (250) has a cylindrical form of circular section.

17. Device according to claim 1, characterized by the fact that the heating portion (250) is coaxial to the central intake part (210).

18. Device according to claim 1, characterized by the fact that the central intake part (210) comprises at least one rib (265, 266) allowing for support and consolidation of the filtration element (220).

19. Device according to claim 1, characterized by the fact that it further comprises a guide tube (115) making it possible to simplify and to secure insertion of the device in a bowl (120).

20. Device according to claim 1, characterized by the fact that it further comprises a sheath (190) for the protection of electrical power wires.

21. Intake device comprising:
a base portion (110),
a heating screen device (200)comprising
a central intake part (210) comprising means of intake (274) associated to a filtration element (220) in direct contact with the fluid to be sucked, and
a heating portion (250) placed in a case (252), separate from the central intake part (210), placed at the periphery of the latter and comprising electric heating elements (292, 294, 296),
said heating screen device being in connection with the base (110) and,
a means for pumping (130) comprising an electric pump.

22. Intake device according to claim 21, characterized in that the electric pump (130) comprises
a first part (132) fastened to the base (110) and comprising an electric motor connected to a magnetic coupling (134, 137) making it possible to magnetically transmit mechanical energy of the motor to
a second part (135), separate from the first part and which comprises pump elements and connected by duct elements (195) to the central intake part (210) of the heating screen device, said second part (135) of the means of pumping being immersed and mechanically independent of the motor in order to guarantee its seal within the fluid.

23. Application of a screen comprising
a central intake part (210) comprising means of intake (274) associated to a filtration element (220) in direct contact with the fluid to be sucked, and
a heating portion (250) placed in a case (252), separate from the central intake part (210), placed at the periphery of the latter and comprising electric heating elements (292, 294, 296), for pumping of urea on motor vehicle, for injection in an exhaust line.
